(19) United States
(12) Patent Application Publication
(10) Pub. No.: US 2007/0012031 A1
(43) Pub. Date: Jan. 18, 2007

(54) FUEL CONTROL FOR DIESEL ENGINE HAVING PARTICULATE FILTER

(75) Inventors: Kenji Tanimura, Hiroshima-shi (JP); Eiji Nakai, Hiroshima-shi (JP); Masanori Sahara, Hiroshima-shi (JP); Shinichi Morinaga, Hiroshima-shi (JP); Kazunari Sasaki, Higashihiroshima-shi (JP)

Correspondence Address: MAZDA NORTH AMERICAN OPERATIONS, c/o FORD GLOBAL TECHNOLOGIES, LLC, 330 TOWN CENTER DRIVE, SUITE 800 SOUTH, DEARBORN, MI, 48126, US

(73) Assignee: Mazda Motor Corporation, Aki-gun (JP)

(21) Appl. No.: 11/456,643

(22) Filed: Jul. 11, 2006

(30) Foreign Application Priority Data
Jul. 13, 2005 (JP) 2005-204643

(51) Int. Cl. F01N 3/10; F02B 3/00

(52) U.S. Cl. 60/285; 123/299; 60/299

(57) ABSTRACT

There is provided a method for fueling a diesel engine having a particulate filter in its exhaust system. The method comprises supplying a main fuel injection to generate a desired torque. It also comprises additionally supplying a first post fuel injection after the main fuel injection and a second post fuel injection after the first post fuel injection during a higher engine load condition. The method further comprises continuing to supply the main fuel injection and the first post fuel injection and stopping to supply the second post fuel injection during a lower engine load condition, if a vehicle cruise control is performed. Therefore, a noticeable torque disturbance can be eliminated.

### BACKGROUND

The present description relates to fuel control for an engine having an exhaust gas purification system, particularly to fuel control for a diesel engine having a particulate filter.

A particulate filter for a diesel engine is well known which traps particulate matter in exhaust gas from the engine therein and can be regenerated by oxidizing the trapped particulate matter after heating it to a certain elevated temperature. In order to heat the particulate filter, it is known and presented, such as in European Patent Application EP1647687A1, to inject additional fuel after a main fuel injection for torque generation, which may be called after-injection or post-injection.

The post fuel injection for this purpose may be typically made during an expansion stroke following the main fuel injection. Then, the post injected fuel may be ignited or reacted with oxygen in the combustion chamber by heat generated from combustion of the main injected fuel. Or, it may react with oxygen at an oxidizing catalyst arranged upstream of the particulate filter. In either case, the post injected fuel may generate heat which can be transferred to the particulate filter. The particulate filter may be heated by the reaction heat, thereby oxidizing particulates trapped in the filter and regenerating the filter.

The filter regeneration may be less efficient when an engine load is lower because the fuel charge is less at low load and the reduced fuel charge provides less energy to heat the exhaust gas. Consequently, filter regeneration may be stopped to save fuel for the filter regeneration or the post fuel injection. In the meantime, the post injected fuel for the filter regeneration may generate some torque from the engine, particularly when it reacts during an expansion stroke. At the low engine load, the torque generated from the post fuel injection may become a larger fraction of the torque from the main fuel injection. Therefore if the post fuel injection is stopped when the engine moves to a low load, then the torque generated from the engine may drop causing a torque disturbance that may disturb an operator.

The inventors herein have recognized the above described disadvantage of the prior art and the need to eliminate the noticeable torque disturbance.

### SUMMARY

Accordingly, in one aspect of the present description, there is provided a method for fueling directly in a combustion chamber of an internal combustion engine, such as a diesel engine, having an exhaust gas purification system, such as a particulate filter, in its exhaust system. The method comprises supplying a main fuel injection, for example around a top dead center of a compression stroke, to generate a desired torque. It also comprises additionally supplying a first post fuel injection after the main fuel injection, such as in an early expansion stroke so that it may be oxidized within the combustion chamber thereby generating torque, and a second post fuel injection after the first post fuel injection, such as in a late expansion stroke or early exhaust stroke so that it may be oxidized in the exhaust system without generating substantial torque, thereby raising a temperature of the exhaust gas purification system, when the engine is in a first operating condition, such as a higher engine load condition. The method further comprises continuing to supply the main fuel injection and the first post fuel injection, and inhibiting the second post fuel injection when the engine moves from the first operating condition to a second operating condition (e.g., such as transitioning to a lower load condition).

In accordance with the method, the engine may transition from a first operating condition to a second operating condition without a substantial change in engine torque. By continuing the main fuel injection during a transition from a first operating condition to a second operating condition, engine toque generated by the engine is substantially maintained. At the same time, fuel consumption can be reduced by stopping the second post fuel injection, since the second post injection may not be useful to regenerate the filter in the second operating condition. For example, the second post injection may be stopped when an engine begins to operate at low load conditions since the exhaust gas temperature may be too low to regenerate the particulate filter.

In another aspect of the present description, there is provided a method for fueling directly in a combustion chamber of an internal combustion engine, such as a diesel engine, on a vehicle, such as a car, having an exhaust gas purification system, such as a particulate filter in its exhaust system. The method comprises supplying a main fuel injection, for example around a top dead center of a compression stroke, to generate a desired torque. The method also comprises additionally supplying a post fuel injection after the main fuel injection, such as in an expansion stroke, thereby raising a temperature of the exhaust gas purification system, if the desired torque is not less than a predetermined amount. For example, it may be a level of torque that corresponds to a main fuel injection amount generating enough heat for the efficient filter regeneration. The method further comprises, if a desired torque is less than the predetermined amount, stopping to supply the post fuel injection in a third operating condition of the engine, or continuing to supply at least a part of the post fuel injection in a fourth operating condition of the engine. For example, the third operating condition may be a condition where the desired torque depends on a vehicle driver's will (e.g., detected by an accelerator pedal depression), thereby making a torque fluctuation less noticeable. The fourth operating condition may be a condition where the desired torque is adjusted to automatically control a speed of the vehicle, such as, to maintain a target vehicle speed, thereby making a torque fluctuation noticeable.

According to the method, the engine may transition from a high load condition to a low load condition without a noticeable change in engine torque. By continuing at least a part of the post fuel injection during a transition from a high load condition to a low load condition, engine torque generated by the engine is substantially maintained during the fourth operating condition, where a torque fluctuation may be noticeable. On the other hand, fuel consumption can be reduced by stopping the post fuel injection during the third operating condition, where a torque fluctuation may be less noticeable.

### BRIEF DESCRIPTION OF THE DRAWINGS

The advantages described herein will be more fully understood by reading an example of an embodiment in which the above aspects are used to advantage, referred to herein as the Detailed Description, with reference to the drawings wherein:

FIG. 1 is a schematic diagram showing a diesel engine according to an embodiment of the present description;

FIG. 2 is a block diagram showing a fuel control system for an engine according to the embodiment of the present description; and

FIG. 3 is a flowchart showing a method for controlling fuel injection to an engine according to the embodiment of the present description.

### DETAILED DESCRIPTION

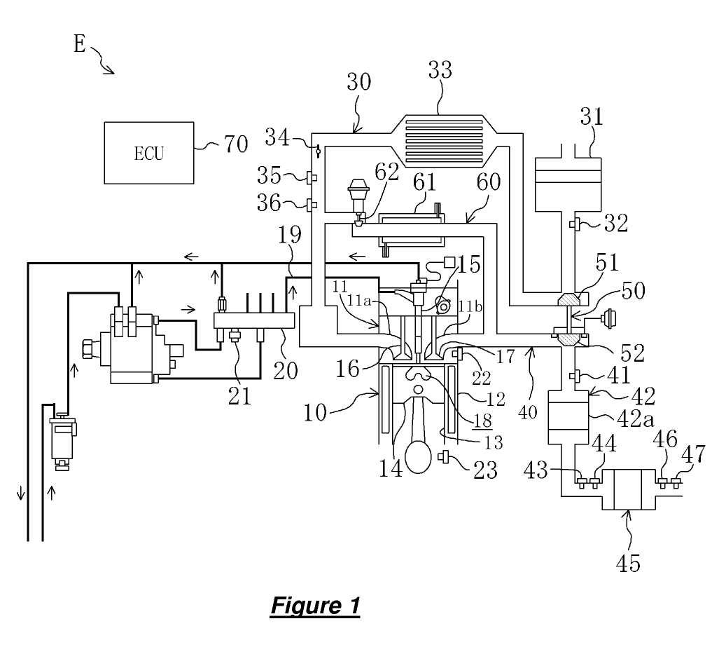

Embodiments of the present description will now be described with reference to the drawings, starting with FIG. 1 which is a view schematically showing an engine system E. The system E comprises an internal combustion engine 10, preferably a diesel engine (hereafter referred to as engine), although it may be a direct injection spark ignited engine, as long as fuel can be directly injected into a combustion chamber. The system E also comprises an intake passage 30 in which air inducted from outside flows, an exhaust passage 40 in which exhaust gas exhausted from said engine 10 flows, a turbocharger 50 in which a compressor 51 and a turbine 52 are coaxially connected, and a controller (ECU) 70 which performs controls of vehicle devices including said engine 10.

The engine 10 comprises a cylinder head 11 within which an intake port 11a and an exhaust port 11b are formed, and a cylinder block 12. Formed in the cylinder block 12 is a cylinder 13, in which a piston 14 is inserted. A space defined by the cylinder head 11, the piston 14 and a wall of the cylinder 13 consists of a combustion chamber 18. The engine 10 also comprises an injector 15 to inject fuel into the combustion chamber, an intake valve 16 open and close an intake passage sequentially with an rotational angle of a crank shaft, which reciprocally moves the piston 14 and output torque from the movement of the piston 14, to induct air into the combustion chamber 18, and an exhaust valve 17 to open and close an exhaust passage also sequentially with an rotational angle of the crank shaft to exhaust combusted gas out of the combustion chamber 18. Although the cylinder 13 shown in FIG. 1 is only one, there may be a plurality of cylinders in the engine 10 and same number of the injectors 15 and the other parts described above.

The injectors 15 are connected through a fuel supply pipes 19 to a common fuel rail 20, to which high pressure fuel is supplied through a fuel delivery system including a high pressure fuel pump from a fuel tank (not shown). A fuel pressure sensor 21 is provided in the common fuel rail 20 to detect a fuel pressure at the common rail 20.

Further, there are provided on the engine 10 an engine coolant temperature sensor 22 to detect temperature of coolant of the engine 10, a crank angle sensor 23 to detect a rotational angle of the crank shaft and eventually its rotational speed.

The intake passage 30 connects through an intake manifold to an intake port 11a at is downstream end, and to an air cleaner 31 at its upstream end. An intake airflow sensor 32, the compressor 1 of the turbocharger 50, an intercooler 33, a throttle valve 34, an intake temperature sensor 35 and an intake pressure sensor 36 are provided sequentially from the upstream side in the intake passage 30.

The intake airflow sensor 32 detects airflow inducted into the engine 10 to output signal to the controller 70. The turbocharger 50 has a variable geometry to make its supercharging efficiency appropriate depending on an engine operating condition such as an engine speed. The intake temperature sensor 35 and intake pressure 36 respectively detect a temperature and a pressure of the inducted air into the engine 10.

The exhaust passage 40 is connected to an exhaust port 11b through an exhaust manifold. The turbine 50 of the turbocharger 50, a first exhaust temperature sensor 41, an oxidizing catalyst converter 42, a second exhaust temperature sensor 43, a first exhaust pressure sensor 44, a diesel particulate filter (DPF, hereafter referred to as filter) 45, a second exhaust pressure sensor 46, and a third exhaust temperature sensor 47 are arranged sequentially from the upstream to downstream in the exhaust passage 40.

The first exhaust temperature sensor 41 detects a temperature of exhaust gas just right upstream of the oxidizing catalyst converter 42, and the second exhaust temperature sensor and the third exhaust temperature sensor 47 respectively detect temperatures of exhaust gas right upstream and downstream of the filter 45. The oxidizing catalyst converter 42 comprises an oxidizing catalyst 42a carrying a catalytic material such as platinum or palladium added, and promotes an oxidizing reaction where CO and HC in exhaust gas are converted to CO₂ and H₂O. The filter 45 traps particulates in exhaust gas (PM: particulates, black smoke and other toxic matters).

Although the oxidizing catalyst converter 42 and the filter 45 are separately provided in this embodiment, the oxidizing catalyst converter 42 may be omitted and the filter 45 may be provided with an oxidizing catalytic function, or both of the filter 45 having the oxidizing catalytic function and the oxidizing catalyst converter 42 may be provided. In either case, the filter 45 will be heated with oxidizing reactive heat from the oxidizing catalyst converter 42 or heated with own oxidizing reactive heat from the filter 45 having the oxidizing catalytic function promoting the oxidizing reaction of the exhaust gas.

The first exhaust pressure sensor 44 and second exhaust gas pressure sensor 46 respectively detect pressures of exhaust gas right upstream and downstream of the filter 45 to output signals to the controller 70. The controller 70 determines a difference between the pressures upstream and downstream of the filter 45 detected by the exhaust pressure sensors 44 and 46 and computes an amount M of particulates trapped in the filter 46 (hereafter referred to as filter trapped amount) based on the determined pressure difference so that the filter trapped amount M is larger as the pressure difference is larger.

A portion of the intake passage 30 downstream of the intake pressure sensor 36 and a portion of the exhaust passage 40 upstream of the turbine 52 are connected through an exhaust gas recirculation passage (hereafter referred to as EGR passage) 66. An EGR cooler 61 and an EGR control valve 62 are provided sequentially from the upstream on the EGR passage 60. The EGR cooler 61 cools the EGR gas flowing in the EGR pipe 60 by introducing the coolant thereto from the engine 10.

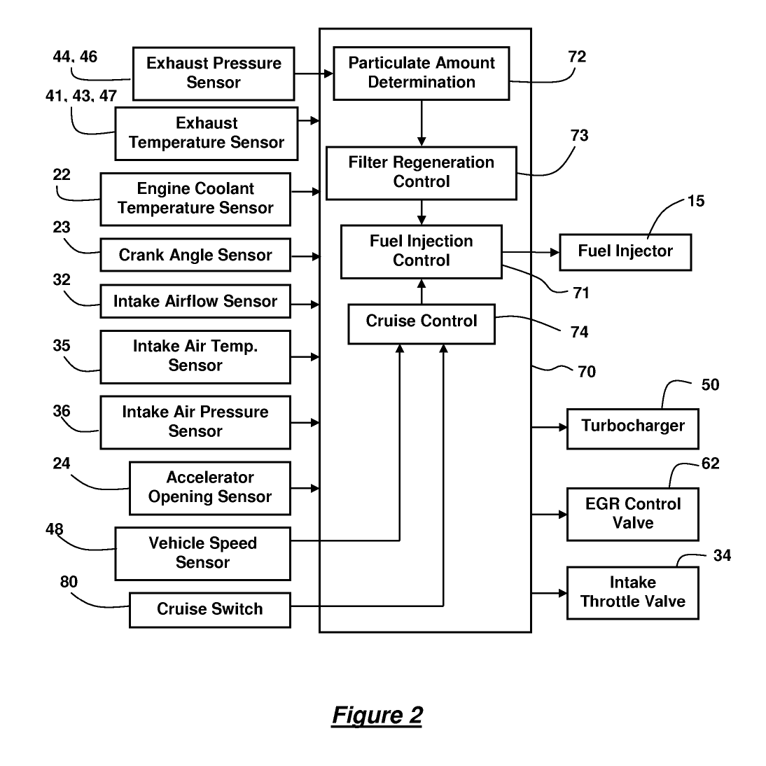

As shown in FIG. 2, the controller 70 controls the injector 15, the throttle valve 34, the turbocharger 50, the EGR control valve 62 and other actuators based on signals input from the sensors described above. The controller 70 comprises input/output (I/O) interface to input and output signals, a memory (ROM and RAM or the like) to store data such as control programs and parameters, a central processing unit (CPU), a counter to count number such as number of times of the filter regeneration, although its physical structure is not illustrated. A fuel injection control section 71 is embodied in a form of a computer program stored in the memory of the controller 70. The fuel injection control section 71 performs a main injection control which causes the injector 15 to inject fuel around a top dead center of a compression stroke of the cylinder 13 to generate an engine output, a post injection control which causes the injector 15 to inject fuel for a regeneration of the filter 45 and a cruise fuel control which causes the injector 15 to inject fuel for a target cruising speed of a vehicle.

The main injection control is basically performed based on an engine rotational speed and an engine load, and further corrected based on an engine coolant temperature, an intake air temperature and other signals input to the controller 70 described above. The engine load may be determined based on a desired fuel injection amount, or may be determined based on an input signal to the controller 70 from an accelerator opening sensor 24 (shown only in FIG. 2) to detect an accelerator opening (depressed amount of an accelerator pedal). For the main injection control, post injection control and cruise control, the fuel injection control section 71 adjusts fuel injection amount and fuel injection timing into the combustion chamber 18.

The post injection control, that is a filter regeneration control, is performed based on signals input from the fist and second exhaust pressure sensors 44 and 46, the crank angle sensor 23, the first through third exhaust temperature sensors 41, 43 and 47, the accelerator opening sensor 24. For the filter regeneration, the controller 70 comprises an exhaust particulate amount determining section 72 and a filter regeneration control section 73 which are embodied in a form of computer program stored in the memory of the controller 70.

The exhaust particulate amount determining section 72 determines the pressure difference between the upstream and the downstream of the filter 45 from exhaust pressures detected by the exhaust pressure sensors 44 and 46, calculates a filter trapped amount M of exhaust particulate based on this pressure difference, and determines if the calculated filter trapped amount is less than a regeneration start value a or not. Although the pressure difference is determined using the first and second exhaust pressure sensors 44 and 46 in this embodiment, a pressure difference sensor may be provided and the detected pressure difference may be directly input to the controller 70.

The filter regeneration will now be described. At first, if the exhaust particulate determining section 72 of the controller 70 determines that a filter trapped amount M is not less than the regeneration start value α and if an engine load read by the controller 70 is not less than the predetermined, the filter regeneration control section 73 causes the injector 15 to inject fuel into the combustion chamber at a following expansion stroke after a main injection of fuel to the combustion chamber around a top dead center of compression stroke (hereafter referring to this injection as first post injection).

Then, fuel injected into the combustion chamber 18 by the first post injection is ignited with a combustion heat from the main fuel injection. Then, the first post injected fuel combusts in the combustion chamber 18, and the combustion heat is generated in the combustion chamber 18 and an exhaust gas temperature is raised by the combustion heat. The exhaust gas flows into the oxidizing catalyst converter 42 to heat the oxidizing catalyst converter 42 resulting to activation of the oxidizing catalyst converter 42.

After the first post injection, the filter regeneration control section 73 causes the injector 15 to inject fuel into the combustion chamber 18 during the same expansion stroke (hereafter referring to this injection as second post injection). Note that while the second post injection is made after the first post injection in this embodiment, the first and second post injections may be made substantially concurrently.

And, unburned fuel injected into the combustion chamber 18 by this second post injection flows to the oxidizing catalyst converter 42 which is activated by the first post injection, the unburned fuel or hydrocarbon (HC) is oxidized in the oxidizing catalyst converter 42 to generate reaction heat, and the oxidizing reaction heat raises a temperature of the exhaust gas. The reheated exhaust gas enters the filter 45 to heat it. As a result, exhaust particulates trapped in the filter 45 combust (firing temperature of the particulates is for example 600° C.) to regenerate the filter 45. As described below, the filter regeneration control will be performed until a filter trapped amount M becomes not more than a regeneration completion value β of the filter regeneration. The regeneration completion value β is smaller than the regeneration start value α.

The cruise control is performed based on signals from a vehicle speed sensor 48 (only illustrated in FIG. 2) detecting vehicle speed, a cruise switch 80 (only illustrated in FIG. 2) and the like. The cruise switch 80 is arranged around a steering wheel in front of a driver's seat, and when this is operated to be ON or OFF, it sends an operational signal corresponding to either ON or OFF to the controller 70. For the cruise control, the controller 70 comprises the cruise control section 74 embodied in a form of computer program stored in the memory of the controller 70.

The cruise control section 74, in a case that the cruise switch 80 is operated ON, performs a cruise control to cause the fuel injection control section 71 to adjust the main fuel injection amount so as to cause a driving speed of the vehicle to be a speed detected at a timing of its ON operation (desired target speed). While a driving speed of the vehicle is maintained to be a speed at a time of ON operation of the cruise switch 80 in this embodiment, it is not limited to this, and for example a driving speed of the vehicle may be coincided with a set speed set based on a predetermined operation of a vehicle occupant or a driver.

On the other hand, if the cruise switch 80 is operated OFF or a brake is applied during a performance of the cruise control, the cruise control section 74 finishes to perform the cruise control.

When an operating condition of the engine 10 transitions to the predetermined lower load condition, the first and second post injections are temporarily stopped to prevent fuel economy deterioration.

However, in a case that the cruise control section 74 performs the cruise control and the filter regeneration control section 73 performs the filter regeneration, when an operating condition of the engine 10 transitions to the predetermined lower load region for example by the vehicle entering a downhill from a flat road and a main injection amount is decreased, if the first post injection is temporarily stopped, there will be a possibility of occurrence of torque shock as described above. On the other hand, in this case, if the second post injection is temporarily stopped, it may not give any influence to the occurrence of torque shock, since the second post injection will not generate any substantial torque due to its late timing in the expansion stroke or exhaust stroke.

Therefore, the filter regeneration control section 73, during the filter regeneration, in a case that the cruise control section 74 performs a cruise control, even when an engine load becomes smaller than the predetermined load, causes the fuel injection control section 71 to make a main fuel injection around a top dead center of a compression stroke, then to continue only the first post fuel injection in the following expansion stroke and to stop the second post fuel injection. Although only the first post injection is continuously made in this embodiment, the second post injection may be continuously performed in addition to the first post injection. However, from a point of view to save unnecessary fuel consumption, it is preferable to continue only the first post injection and stop the second post injection.

On the other hand, during the filter regeneration, in a case that the cruise control section 74 does not perform a cruise control, in other words, the engine torque is adjusted by a vehicle driver, when an engine load becomes smaller than the predetermined load, the filter regeneration control section 73 causes the fuel injection control section 71 to make a main injection around a top dead center of a compression stroke, and then to stop the first and second post injections. In this case the driver or other vehicle occupants are not likely to notice the torque shock, because the vehicle is most likely to have transitioned from a constant speed cruising or acceleration to a deceleration so that the transition itself may overcome a torque decrease caused by the stop of the first post fuel injection.

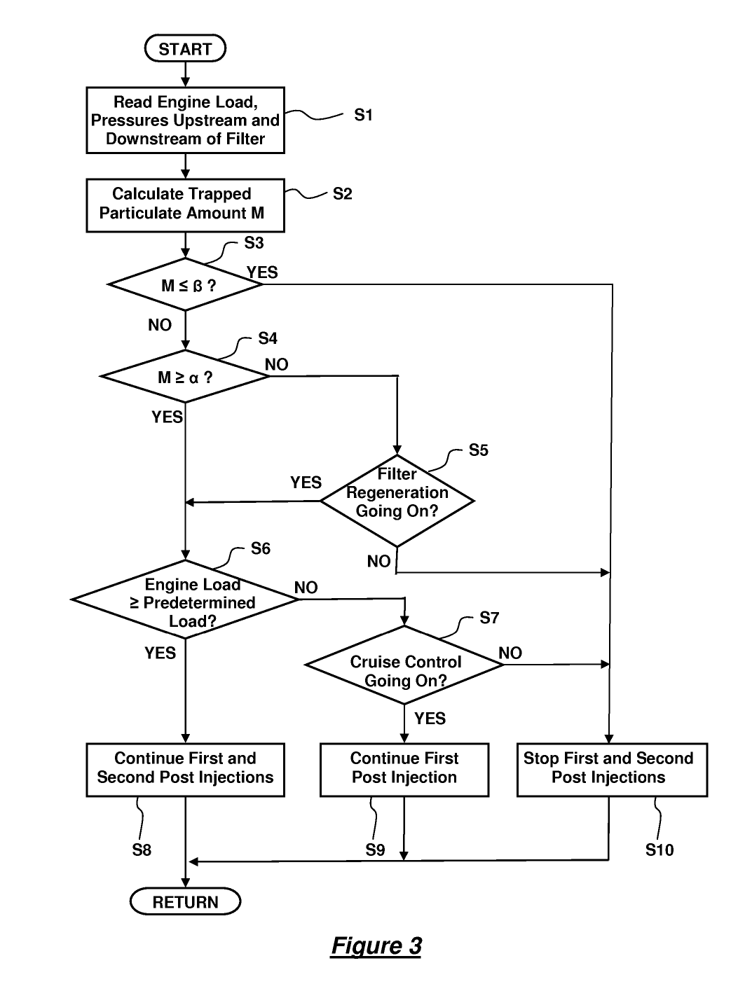

The filter regeneration control by the controller 70 will now be described with reference to a flowchart of FIG. 3. At a step S1, an engine load determined based on a desired fuel injection amount and exhaust gas pressures upstream and downstream of the filter 45 detected by the exhaust pressure sensors 44 and 46 are read. At a step S2, a trapped particulate amount M is calculated based on the read exhaust pressures upstream and downstream of the filter 45.

At a step S3, it is determined whether the calculated trapped particulate amount M is equal to or less than the regeneration completion value β of filter regeneration. If a determined result of the step S3 is YES, it proceeds to a step S10, and if NO, it proceeds to a step S4.

At the step S4, it is determined whether the calculated trapped particulate amount M is equal to or more than the regeneration start value a of filter regeneration. If a determined result of the step S4 is YES, it proceeds to a step S6, and if NO, it proceeds to a step S5. At the step S5, it is determined whether a filter regeneration control is going on or not. If a determined result of the step S5 is YES, it proceeds to the step S6, and if NO, it proceeds to the step S10.

At the step S6, it is determined whether the read engine load is the predetermined load or not. If a determined result of the step S6 is YES, it proceeds to a step S8, and if NO, it proceeds to a step S7. At the step S7, it is determined whether a cruise control is going on or not. If a determined result of the step S7 is YES, it proceeds to a step S9, and if NO, it proceeds to a step S10.

At the step S8, if currently a filter regeneration control is not going on, a filter regeneration control is started to make first and second post injections during an expansion stroke, and if currently a filter regeneration control is going on, the first and second post injections are continued to be made during an expansion stroke. Then it proceeds to RETURN.

At the step S9, if currently a filter regeneration control is not going on, a filter regeneration control is started to make only a first post injection in an expansion stroke, and if currently a filter regeneration control is going on, only a first post injection is continued to be made in an expansion stroke. Then it proceeds to RETURN.

At the step S10, if currently a filter regeneration control is not going on, no filter regeneration control is started (in other words, first and second post injections are not made in an expansion stroke), and if currently a filter regeneration control is going on, first and second post injections in an expansion stroke are stopped. Then, it proceeds to RETURN.

As may be realized by those skilled in the art, it is intended that the sequence of the processing steps described above is merely for illustrative and exemplary purposes and that a different sequence or simultaneous or parallel processing may be possible as long as the intended result can be obtained from such a processing.

According to the above embodiment, during a filter regeneration performed, if the cruise control section 74 of the controller 70 performs a cruise control, even when an engine load becomes smaller than the predetermined load, the filter regeneration control section 73 causes the fuel injection control section 71 to continue the first post injection. Accordingly, an occurrence of torque shock can be prevented, which can occur by stopping the first post injection when an engine operating condition has entered the predetermined low load region where an efficiency of the filter regeneration is not good, in a case that the cruise control section 71 performs a cruise control during a filter regeneration where a torque shock can be noticeable.

Although, in the above embodiment, the filter regeneration means 73 performs the filter regeneration control based on an engine load based on a required fuel injection amount, a grade detection sensor to detect a grade of a road on which a vehicle drives may be provided, an engine load may be determined based on a grade detected by the grade detection sensor, and the filter regeneration means 73 may perform such a filter regeneration as described above based on the determined engine load.

It is needless to say that the invention is not limited to the illustrated embodiment and that various improvements and alternative designs are possible without departing from the substance of the invention as claimed in the attached claims.

1. A method for fueling directly in a combustion chamber of an internal combustion engine having an exhaust gas purification system in its exhaust system, comprising:
supplying a main fuel injection to generate a desired torque;
additionally supplying a first post fuel injection after said main fuel injection and a second post fuel injection after said first post fuel injection during a first operating condition; and
continuing to supply said main fuel injection and said first post fuel injection and stopping to supply said second post fuel injection during a second operating condition.

2. The method as described in claim 1, wherein said second operating condition comprises said desired torque being less than a predetermined amount.

3. The method as described in claim 1, wherein said first post injection is supplied into said combustion chamber at a timing so as to be oxidized within said combustion chamber.

4. The method as described in claim 3, wherein said second post injection is supplied into said combustion chamber at a timing so as to be oxidized in said exhaust system downstream of said combustion chamber.

5. The method as described in claim 4, wherein said second post injection is oxidized at an oxidizing catalyst arranged upstream of said exhaust gas purification system.

6. The method as described in claim 1, further comprising:
trapping particulates in exhaust gas from said engine in said exhaust gas purification system; and
regenerating said exhaust gas purification system by oxidizing the particulates trapped in said exhaust gas purification system after said supplying the first and second post injections to raise the temperature of said exhaust gas purification system.

7. The method as described in claim 6, wherein said first post injection is supplied into said combustion chamber at a timing so as to be oxidized within said combustion chamber.

8. The method as described in claim 7, wherein said second post injection is supplied into said combustion chamber at a timing so as to be oxidized in said exhaust system downstream of said combustion chamber.

9. The method as described in claim 8, wherein said second post injection is oxidized at an oxidizing catalyst arranged upstream of said exhaust gas purification system.

10. A method for fueling directly in a combustion chamber of an internal combustion engine on a vehicle having an exhaust gas purification system in its exhaust system, comprising:
supplying a main fuel injection to generate a desired torque;
additionally supplying a post fuel injection after said main fuel injection if said desired torque is more than a predetermined amount; and
if a desired torque is less than said predetermined amount, stopping to supply said post fuel injection in a third operating condition of said engine or continuing to supply at least a part of said post fuel injection in a fourth operating condition of said engine.

11. The method as described in claim 10, further comprising:
adjusting said desired torque to automatically control a speed of a vehicle which said engine drives, and
wherein said fourth operating condition is met when the vehicle speed is automatically controlled.

12. The method as described in claim 11, wherein the vehicle speed is controlled so as to maintain its target speed.

13. The method as described in claim 10, wherein said post fuel injection comprises a first post fuel injection and a second post fuel injection to be made after said first post fuel injection, and
wherein said first post fuel injection is continued in said fourth operating condition.

14. The method as described in claim 13, wherein said first post injection is supplied into said combustion chamber at a timing so as to be oxidized within said combustion chamber.

15. The method as described in claim 14, wherein said second post injection is supplied into said combustion chamber at a timing so as to be oxidized in said exhaust system downstream of said combustion chamber.

16. The method as described in claim 11, further comprising:
trapping particulates in exhaust gas from said engine in said exhaust gas purification system; and
regenerating said exhaust gas purification system by oxidizing the particulates trapped in said exhaust gas purification system after said supplying the first and second post injections to raise the temperature of said exhaust gas purification system.

17. An engine system comprising:
an internal combustion engine;
a fuel injector supplying fuel directly into a combustion chamber of said engine;
an exhaust gas purification system arranged in an exhaust system of said engine; and
a controller configured to control said fuel injector to:
supply a main fuel injection to generate a desired torque;
additionally supply a first post fuel injection after said main fuel injection and a second post fuel injection after said first post fuel injection in an expansion stroke of the same engine cycle as said main fuel injection is supplied during a first operating condition; and
continue to supply said main fuel injection and said first post fuel injection and stop to supply said second post fuel injection during a second operating condition.

18. The engine system as described in claim 17, wherein said exhaust gas purification system comprises a particulate filter adapted to trap particulates from exhaust gas from said engine and to be regenerated by oxidizing the particulates trapped therein after supplying said first and second post injections.

19. The engine system as described in claim 18, wherein said exhaust gas purification system further comprises an oxidizing catalyst upstream of said particulate filter where said second post fuel injection can be oxidized.

20. The engine system as described in claim 18, further comprising a sensor configured to detect a difference between pressures upstream and downstream of said particulate filter, and
wherein said controller further configured to control said fuel injector to additionally supply said first and second post fuel injection when said sensor detects said pressure difference more than a predetermined value.
